(19) United States
(12) Patent Application Publication
(10) Pub. No.: US 2026/0280856 A1
(43) Pub. Date: Sep. 17, 2026

(54) SECURE MULTI-PARTY COMPUTATION METHODS AND APPARATUSES

(71) Applicant: ALIPAY (HANGZHOU) INFORMATION TECHNOLOGY CO., LTD., Hangzhou (CN)

(72) Inventors: Wuqiong PAN, Hangzhou (CN); Tianyi LI, Hangzhou (CN); Tingting LI, Hangzhou (CN); Tao WEI, Hangzhou (CN); Zhenqiang WEI, Hangzhou (CN); Yongtao HU, Hangzhou (CN)

(21) Appl. No.: 18/872,010

(22) PCT Filed: Aug. 9, 2023
(86) PCT No.: PCT/CN2023/111951

§ 371 Date: Dec. 5, 2024

(30) Foreign Application Priority Data
Dec. 26, 2022 (CN) 202211674733.4

(51) Int. Cl. H04L 9/08

(52) U.S. Cl. CPC H04L 9/085; H04L 2209/46

(57) ABSTRACT

Embodiments of this specification provide secure multi-party computation methods and apparatuses. The secure multi-party computation method is used to perform at least one type of target processing on a batch of data. The secure multi-party computation method is performed by any first participant in the n participants, and includes: dividing local shards of each piece of data in the batch of data into m groups, and correspondingly allocating the m groups to m groups of threads; and performing, on the m groups in parallel by using the m groups of threads, each type of target processing jointly performed with another participant, where the first participant serves as different secure multi-party computation (MPC) roles in at least some of the m groups of threads, and the different MPC roles perform different target computation and/or target transmission for a type of target processing.

This specification claims priority to Chinese Patent Application No. 202211674733.4, filed with the China National Intellectual Property Administration on Dec. 26, 2022 and entitled “SECURE MULTI-PARTY COMPUTATION METHODS AND APPARATUSES”, which is incorporated here by reference in its entirety.

### TECHNICAL FIELD

One or more embodiments of this specification relate to the field of secure multi-party computation technologies, and in particular, to secure multi-party computation methods and apparatuses.

### BACKGROUND

Privacy computing is the main support technology in the data encryption era, and can provide capabilities of “computable but invisible” and “data stay static while value moves”.

Secure multi-party computation (MPC) is an important technology in privacy computing, and means that a plurality of participants jointly compute a result based on a cryptographic protocol without leaking any data information to other participants.

In secure multi-party computation, a large quantity of interactions are performed between the plurality of participants, and network transmission consumption is one of main bottlenecks.

### SUMMARY

One or more embodiments of this specification describe secure multi-party computation methods and apparatuses, to effectively improve network resource and computing resource utilization.

According to a first aspect, a secure multi-party computation method is provided. The method is used to perform at least one type of target processing on a batch of data. Each piece of data in the batch of data is distributed to n participants in a form of shards, and the method is performed by any first participant in the n participants, and includes:
dividing local shards of each piece of data in the batch of data into m groups, and correspondingly allocating the m groups to m groups of threads; and
performing, on the m groups in parallel by using the m groups of threads, each type of target processing jointly performed with another participant, where the first participant serves as different secure multi-party computation (MPC) roles in at least some of the m groups. of threads, and the different MPC roles perform different target computation and/or target transmission for a type of target processing.

In a possible implementation, performing, on the m groups in parallel by using the m groups of threads, each type of the target processing jointly performed with another participant includes:
jointly performing, by using an i^{th} group of threads and based on a local shard of a first group that is allocated to the i^{th} group of threads, first computation and first transmission with another group of threads to which another shard of the first group is allocated in the another participant, to implement a type of target processing on the first group, where the first computation and the first transmission correspond to a first role of the first participant in the i^{th} group of threads.

In a possible implementation, the type of target processing is truncation processing, and the different MPC roles include a computing party and a receiving party.

In a possible implementation, the first group includes first data, and the first role is the computing party;
the first computation includes: generating a first random number within an agreed value range; dividing the first random number by 2 raised to the power of t to obtain a first quotient; and determining a first shard of a truncation processing result of the first data based on at least the first quotient, where t is the quantity of truncated bits; and
the first transmission includes: sending a difference between a first shard of the first data and the first random number to a second participant serving as the receiving party, so that the second participant determines a second shard of the truncation processing result based on at least the difference, the quantity of truncated bits, and a second shard of the first data that is held by the second participant.

In a possible implementation, the first group includes first data, and the first role is the receiving party;
the first transmission includes: receiving, from a second participant serving as the computing party, a difference, calculated by the second participant, between a second shard of the first data that is held by the second participant and a first random number; and
the first computation includes: summing the difference and a first shard of the first data, and dividing a summation result by 2 raised to the power of t to obtain a second quotient; and determining a first shard of a truncation processing result based on the second quotient.

In a possible implementation, the at least one type of target processing includes oblivious transfer (OT), logical quantity to digital quantity conversion, digital quantity to logical quantity conversion, multiplication of a digital quantity and a logical quantity, encrypted-state selection, and out-of-order processing.

In a possible implementation, dividing the local shards of each piece of data in the batch of data into m groups includes:
equally dividing the local shards of each piece of data in the batch of data into the m groups.

In a possible implementation, the n participants hold the same quantity of shards for the same piece of data in the batch of data.

In a possible implementation, the batch of data are unevenly distributed to the n participants, and an MPC role of each of the n participants is determined based on data currently held by the participant.

In a possible implementation, the m groups include a first group, and the type of target processing on the first group is performed by p participants including the first participant in the n participants, where p<n.

In a possible implementation, the m groups of threads include different quantities of threads.

In a possible implementation, the n participants run different quantities of threads.

According to a second aspect, a secure multi-party computation apparatus is provided. The apparatus is configured to perform at least one type of target processing on a batch of data. Each piece of data in the batch of data is distributed to n participants in a form of shards, and the apparatus is disposed in any first participant in the n participants, and includes:
a division unit, configured to divide local shards of each piece of data in the batch of data into m groups, and correspondingly allocate the m groups to m groups of threads; and
an execution unit, configured to perform, on the m groups in parallel by using the m groups of threads, each type of target processing jointly performed with another participant, where the first participant serves as different secure multi-party computation (MPC) roles in at least some of the m groups of threads, and the different MPC roles perform different target computation and/or target transmission for a type of target processing.

In a possible implementation, the execution unit is specifically configured to:
jointly perform, by using an i^{th} group of threads and based on a local shard of a first group that is allocated to the i^{th} group of threads, first computation and first transmission with another group of threads to which another shard of the first group is allocated in the another participant, to implement the type of target processing on the first group, where the first computation and the first transmission correspond to a first role of the first participant in the i^{th} group of threads.

In a possible implementation, the type of target processing is truncation processing, and the different MPC roles include a computing party and a receiving party.

In a possible implementation, the first group includes first data, and the first role is the computing party; and the execution unit includes:
a first computation module, configured to generate a first random number within an agreed value range; divide the first random number by 2 raised to the power of t to obtain a first quotient; and determine a first shard of a truncation processing result of the first data based on at least the first quotient, where t is the quantity of truncated bits; and
a first transmission module, configured to send a difference between a first shard of the first data and the first random number to a second participant serving as the receiving party, so that the second participant determines a second shard of the truncation processing result based on at least the difference, the quantity of truncated bits, and a second shard of the first data that is held by the second participant.

In a possible implementation, the first group includes first data, and the first role is the receiving party; and the execution unit includes:
a second transmission module, configured to receive, from a second participant serving as the computing party, a difference, calculated by the second participant, between a second shard of the first data that is held by the second participant and a first random number; and
a second computation module, configured to sum the difference and a first shard of the first data, and divide a summation result by 2 raised to the power of t to obtain a second quotient; and determine a first shard of a truncation processing result based on the second quotient.

In a possible implementation, the at least one type of target processing includes oblivious transfer (OT), logical quantity to digital quantity conversion, digital quantity to logical quantity conversion, multiplication of a digital quantity and a logical quantity, encrypted-state selection, and out-of-order processing.

In a possible implementation, the division unit is specifically configured to:
equally divide the local shards of each piece of data in the batch of data into the m groups.

In a possible implementation, the n participants hold the same quantity of shards for the same piece of data in the batch of data.

In a possible implementation, the batch of data are unevenly distributed to the n participants, and an MPC role of each of the n participants is determined based on data currently held by the participant.

In a possible implementation, the m groups include a first group, and the type of target processing on the first group is performed by p participants including the first participant in the n participants, where p<n.

In a possible implementation, the m groups of threads include different quantities of threads.

According to a third aspect, a computer-readable storage medium is provided. The computer-readable storage medium stores a computer program. When the computer program is executed in a computer, the computer is enabled to perform the method according to the first aspect or the second aspect.

According to a fourth aspect, a computing device is provided. The computing device includes a memory and a processor. The memory stores executable code. When executing the executable code, the processor implements the method according to the first aspect or the second aspect.

According to the secure multi-party computation methods and apparatuses provided in one or more embodiments of this specification, in a process of performing target processing on a batch of data, MPC roles of participants can be exchanged. In secure multi-party computation in most cases, computation amounts or transmission amounts of different MPC roles are different. Therefore, in the solutions, each participant can perform MPC role switching, so that resources (including network resources and computing resources) of each participant can be effectively utilized.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following descriptions show merely some embodiments of this specification, and a person of ordinary skill in the art can still derive other drawings from these accompanying drawings without creative efforts.

FIG. 1 is a schematic diagram illustrating an implementation scenario of one or more embodiments disclosed in this specification;

FIG. 2 is a flowchart illustrating a secure multi-party computation method, according to one or more embodiments;

FIG. 3 is a schematic diagram illustrating a data truncation processing method; and

FIG. 4 is a schematic diagram illustrating a secure multi-party computation apparatus, according to one or more embodiments.

### DESCRIPTION OF EMBODIMENTS

The solutions provided in this specification are described below with reference to the accompanying drawings.

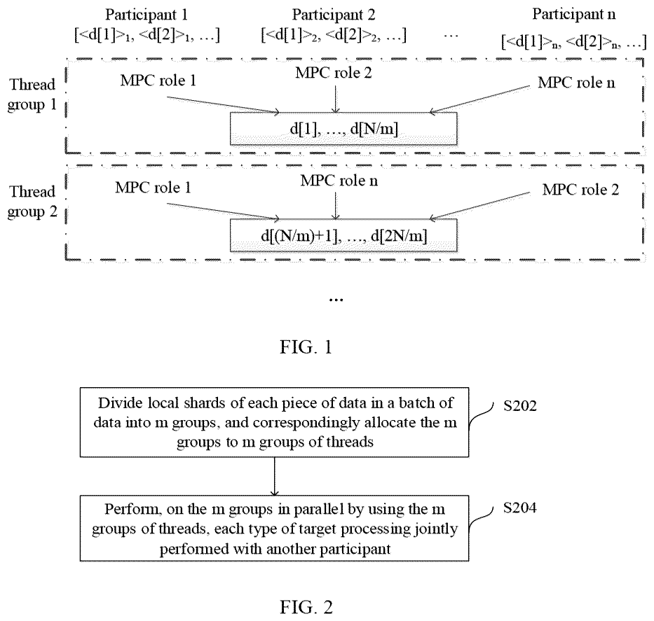

FIG. 1 is a schematic diagram illustrating an implementation scenario of one or more embodiments disclosed in this specification. In FIG. 1, n participants jointly perform at least one type of target processing on a batch of data. Each participant can be implemented as any device, platform, server, or device cluster with computing and processing capabilities.

The at least one type of target processing includes some of truncation processing, oblivious transfer (OT), logical quantity to digital quantity conversion, digital quantity to logical quantity conversion, multiplication of a digital quantity and a logical quantity, encrypted-state selection, or out-of-order processing.

Each piece of data d[j] in the batch of data is distributed to the n participants in a form of shards, where j is a positive integer, I≤j≤N, and N is a total amount of the batch of data. For example, participant 1 holds shards <d[1]>₁, <d[2]>₁, . . . , participant 2 holds shards <d[1]>₂, <d[2]>₂, . . . , and participant n holds shards <d[1]>ₙ, <d[2]>ₙ, . . . .

Specifically, each participant can locally run m groups of threads: thread group 1 to thread group m, to perform each type of target processing on the batch of data, and each participant can serve as different secure multi-party computation (MPC) roles in at least some of the m groups of threads that the participant runs. For example, participant 1 serves as MPC role 1 in thread group 2, participant 2 serves as MPC role n in thread group 2, and participant n serves as MPC role 2 in thread group 2. Then the participants can use thread groups 2 that the participants run to jointly perform a type of target processing on data of one group d[j], . . . , and d[x], where x is a positive integer, and 1≤x≤N.

It should be understood that the thread group numbers (for example, 1 and 2) are only used to distinguish between thread groups processing different shard groups. For example, thread group 1 running in participant 1 and thread group 1 running in participant 2 are thread groups used by two participants to process the same shard group, but do not indicate that participant 1 and participant 2 run the same thread group.

In addition, for each piece of data in a batch of data, each participant can hold only one shard, or can hold two or more shards. For example, the shards held by participant I can alternatively be <d[1]>₁, <d[1]>₂, <d[2]>₁, <d[2]>₂, . . . , provided that MPC roles of the participants can be exchanged. Implementations are not limited in this specification.

It is worthwhile to note that in actual applications, a type of target processing on each of the m groups can alternatively be performed by p participants in the n participants, where p<n. In other words, the remaining n-p participants do not perform any computation for the type of target processing, and therefore can be considered as serving as empty roles.

Finally, it is worthwhile to note that the quantities of threads that the n participants run can be different. In other words, the total quantity of threads in m groups of threads that each of the n participants runs is different.

FIG. 2 is a flowchart illustrating a secure multi-party computation method, according to one or more embodiments. The method can be performed by any apparatus, device, platform, or device cluster having computing and processing capabilities. For example, the method can be performed by any first participant in the n participants in FIG. 1. As shown in FIG. 2, the method can include the following steps.

Step S202: Divide local shards of each piece of data in a batch of data into m groups, and correspondingly allocate the m groups to m groups of threads.

It is worthwhile to note that each piece of data in the batch of data is distributed to the n participants in a form of shards. In an example, the n participants hold the same quantity of shards for the same piece of data in the batch of data. In other words, the batch of data are equally distributed to the n participants.

For example, participant 1 holds shards <d[1]>₁, <d[2]>₁, . . . , participant 2 holds shards [1]>₂, <d[2]>₂, . . . , and participant n holds shards <[1]>ₙ, <d[2]ₙ, . . . .

For another example, participant 1 holds shards <d[1]>₁, <d[1]>₂, <d[2]>₁, <d[2]>₂, . . . , and participant 2 holds shards <d[1]>₂, <d[1]>₃, <d[2]>₂, <d[2]>₃, . . . .

In another example, the batch of data can alternatively be unevenly distributed to the n participants, and an MPC role of each of the n participants is determined based on data currently held by the participant.

Step S202 can be specifically equally dividing the local shards of each piece of data in the batch of data into the m groups. Therefore, the m groups are also referred to as m shard groups.

For example, assume that the batch of data are respectively represented as d[1] , d[2], d[3], . . . , and d[N], where N is a total amount of the batch of data. In this case, the m groups obtained through equal division can be respectively represented as d[1], . . . , d[N/mm], d[(N/m)+1], . . . , d[2 N/m], . . . , d[N(m−1)/m], . . . , and d[N].

It should be understood that because a participant holds only a data shard, each participant actually divides local shards of each piece of data in the batch of data into groups, and each of m obtained groups includes a local shard of each piece of data.

In addition, the m groups of threads can include different quantities of threads.

Step S204: Perform, on the m groups in parallel by using the m groups of threads, each type of target processing jointly performed with another participant.

The target processing here can include any one of the following: truncation processing (also referred to as right shift processing), oblivious transfer (OT), logical quantity to digital quantity conversion, etc.

The target processing includes some of truncation processing, oblivious transfer (OT), logical quantity to digital quantity conversion, digital quantity to logical quantity conversion, multiplication of a digital quantity and a logical quantity, encrypted-state selection, or out-of-order processing.

The first participant serves as different secure multi-party computation (MPC) roles in at least some of the m groups of threads, and the different MPC roles perform different target computation and/or target transmission for a type of target processing.

Taking a type of target processing as an example, step S204 is specifically jointly performing, by using an i^{th} group of threads and based on a local shard of a first group that is allocated to the i^{th} group of threads, first computation and first transmission with another group of threads to which another shard of the first group is allocated in the another participant, to implement a type of target processing on the first group, where the first computation and the first transmission correspond to a first role of the first participant in the i^{th} group of threads, where 1≤i≤m.

It should be understood that because target processing processes of different pieces of data in the same group are similar, a type of target processing on a certain piece of data is used as an example for description below. In addition, it should be understood that processing processes of an allocated shard group in different thread groups are also similar.

For example, the first participant is participant 1 in FIG. 1. The i^{th} group of threads can be thread group 1 running in participant 1, and the another group of threads can be thread groups I running in participant 2 to participant n, in other words, the i^{th} group of threads and the another group of threads are used to jointly perform a type of target processing on the same shard group.

For example, if the target processing is the truncation processing, the MPC role can include a computing party and a receiving party.

When the first participant serves as the computing party, in other words, when the first role is the computing party, the first computation can include the following:

For any first data in the first group, the first participant generates a first random number within an agreed value range; divides the first random number by 2 raised to the power of t to obtain a first quotient; and determines a first shard of a truncation processing result of the first data based on at least the first quotient, where t is the quantity of truncated bits.

In an example, the agreed value range can be, for example, [2⁻⁶³, 2⁶³], the first random number can be represented as r′, and the first quotient can be represented as r′/2^{t}.

In an example, the first participant can use a difference between the first quotient and shared random number r₀ as a first shard of the truncation processing result of the first data, and use the agreed random number as another first shard.

In addition, the first transmission can include: sending a difference between a first shard of the first data and the first random number to a second participant serving as the receiving party, so that the second participant determines a second shard of the truncation processing result based on at least the received difference, the quantity of truncated bits, and a second shard of the first data that is held by the second participant.

For example, the second participant can sum the received difference and the second shard of the first data that is held by the second participant, and divide a summation result by 2 raised to the power of t to obtain a second quotient. Then the second participant can determine the second quotient as a second shard of the truncation processing result that is held by the second participant, and use the shared random number as another second shard.

Certainly, in actual applications, the second participant can alternatively receive the another second shard from the first participant. Details are omitted for simplicity in this specification.

The first participant serves as the computing party in the above-mentioned descriptions, and the first participant serves as the receiving party in the following descriptions.

When the first participant serves as the receiving party, in other words, when the first role is the receiving party, the first transmission can include:
receiving, from a second participant serving as the computing party, a difference, calculated by the second participant, between a second shard of the first data that is held by the second participant and a first random number.

For the definition of the first random number here, references can be made to the above-mentioned descriptions. Details are omitted here for simplicity in this specification.

The first computation can include:
summing the received difference and a first shard of the first data that is held by the first participant, dividing a summation result by 2 raised to the power of't to obtain a second quotient, and determining, based on the second quotient, a first shard of a truncation processing result that is held by the first participant.

In an example, the first participant can use the calculated second quotient as a first shard of the truncation processing result that is held by the first participant, and use a shared random number as another first shard.

Certainly, in actual applications, the first participant can alternatively receive the another first shard from the second participant. Details are omitted for simplicity in this specification.

The following describes the secure computation method provided in the solutions with reference to a specific example.

FIG. 3 is a schematic diagram illustrating a data truncation processing method. In FIG. 3, three participants A, B, and C jointly perform truncation processing on data x. Data x are split into three shards: x₀, x₁, and x₂. Participant A holds shards x₀ and x₁, participant B holds shards x₁ and x₂, and participant C holds shards x₀ and x₂.

In FIG. 3, participant C serves as a computing party, and participant A and participant B serve as receiving parties. Specifically, participant C can perform the following computation: First random numbers r′ and r₁ are generated, where r′∈[2⁻⁶³, 2⁶³]. In addition, shared random number r₀ with participant A can be further generated. Then second random number r₂=(r′/2^{t})−r₀−r₁ is computed. Then participant C can use r₀ as shard z₀ of truncation processing result z of data x that is held by participant C, and use the sum of r₁ and r₂ as another shard z₂ of z.

In addition to the above-mentioned computation, participant C can further perform the following transmission:

A difference x₂−r′ between shard x₂ of data x and first random number r′ is sent to participant A, so that participant A uses shared random number r₀ with participant C as shard z₀ of z that is held by participant A. In addition, participant A can further sum the received difference x₂−r′ and the shards x₀ and x₁ of data x that are held by participant A, divide a summation result by 2 raised to the power of t to obtain a quotient (x₂−r′+x₀+x₁)/2^{t}, and use the quotient as another shard z₁ of z that is held by participant A.

A difference x₀−r′ between shard x₀ of data x and first random number r′ is sent to participant B. In addition, shard z₂ can be further sent to participant B, so that participant B can use received shard z₂ as shard z₂ of z that is held by participant B. In addition, participant B can further sum the received difference x₂−r′ and shards x₁ and x₂ of data x that are held by participant B, divide a summation result by 2 raised to the power of t to obtain a quotient (x₀−r′+x₁+x₂)/2^{t}, and use the quotient as another shard z₁ of z that is held by participant B.

It can be seen from the example that no data are transmitted between participant A and participant B, data are transmitted between participant A and participant C and between participant B and participant C, and a relatively large amount of data are transmitted between participant B and participant C. Therefore, in the above-mentioned secure multi-party computation process, a part of network bandwidth is fully occupied, and a part of network bandwidth is underutilized.

To balance network resources, in another group of threads running in parallel with the thread group processing data x, roles of the participants can be exchanged. For example, in a thread group processing data y, participant A can switch to the role of participant C, so that participant A performs the above-mentioned computation and transmission of participant C.

It should be understood that in a plurality of thread groups running in parallel, MPC roles of participant A, participant B, and participant C are exchanged, so that network resources between every two of the three participants can be effectively utilized, thereby greatly improving network resource utilization.

In the above-mentioned descriptions, there are three participants. In actual applications, when there are two participants, a problem of effective utilization of bidirectional bandwidth exists. Therefore, the concept of MPC role switching in the solutions can be used for reference.

In addition, in the MPC role switching method in the solutions, computing resource utilization can be further improved.

In conclusion, in the solutions, each participant performs MPC role switching, so that network resources and computing resources of each participant can be effectively utilized.

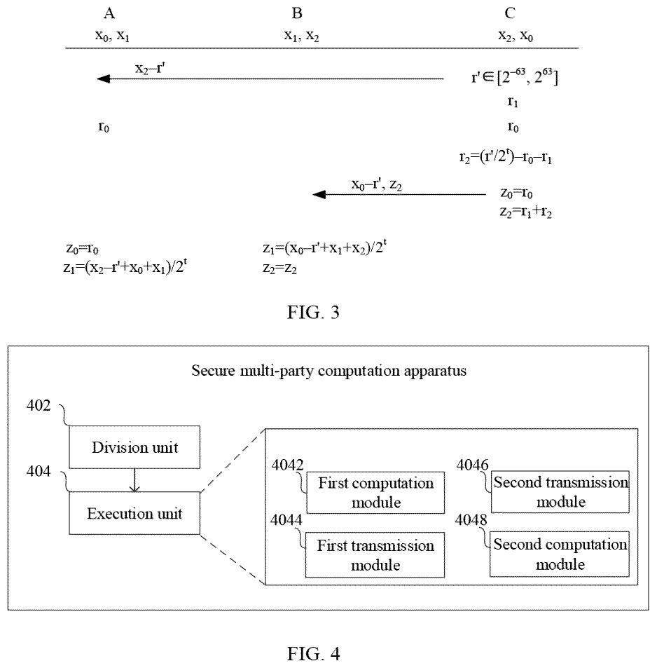

Corresponding to the above-mentioned secure multi-party computation method, one or more embodiments of this specification further provide a secure multi-party computation apparatus, configured to perform at least one type of target processing on a batch of data. Each piece of data in the batch of data is distributed to n participants in a form of shards, and the apparatus is disposed in any first participant in the n participants. As shown in FIG. 4, the apparatus can include a division unit 402 and an execution unit 404, wherein:
a division unit 402, configured to divide local shards of each piece of data in the batch of data into m groups, and correspondingly allocate the m groups to m groups of threads.

In some embodiments, the m groups of threads include different quantities of threads.

In some embodiments, the batch of data are unevenly distributed to the n participants, and an MPC role of each of the n participants is determined based on data currently held by the participant.

In some embodiments, the n participants hold the same quantity of shards for the same piece of data in the batch of data.

The division unit 402 is specifically configured to:
equally divide the local shards of each piece of data in the batch of data into the m groups.

An execution unit 404 is configured to perform, on the m groups in parallel by using the m groups of threads, each type of target processing jointly performed with another participant, where the first participant serves as different secure multi-party computation (MPC) roles in at least some of the m groups of threads, and the different MPC roles perform different target computation and/or target transmission for a type of target processing.

The execution unit 404 is specifically configured to jointly perform, by using an i^{th} group of threads and based on a local shard of a first group that is allocated to the i^{th} group of threads, first computation and first transmission with another group of threads to which another shard of the first group is allocated in the another participant, to implement target processing on the first group, where the first computation and the first transmission correspond to a first role of the first participant in the i^{th} group of threads.

In some embodiments, the at least one type of target processing includes some of truncation processing, oblivious transfer (OT), logical quantity to digital quantity conversion, digital quantity to logical quantity conversion, multiplication of a digital quantity and a logical quantity, encrypted-state selection, or out-of-order processing.

In some other embodiments, the type of target processing is truncation processing, and different MPC roles include a computing party and a receiving party.

The first group includes first data, the first role is the computing party, and the execution unit 404 includes:
a first computation module 4042, configured to generate a first random number within an agreed value range; divide the first random number by 2 raised to the power of t to obtain a first quotient; and determine a first shard of a truncation processing result of the first data based on at least the first quotient, where t is the quantity of truncated bits; and
a first transmission module 4044, configured to send a difference between a first shard of the first data and the first random number to a second participant serving as the receiving party, so that the second participant determines a second shard of the truncation processing result based on at least the difference, the quantity of truncated bits, and a second shard of the first data that is held by the second participant.

In some other embodiments, the first group includes first data, the first role is the receiving party, and the execution unit 404 includes:
a second transmission module 4046, configured to receive, from a second participant serving as the computing party, a difference, calculated by the second participant, between a second shard of the first data that is held by the second participant and a first random number; and
a second computation module 4048, configured to sum the received difference and a first shard of the first data, divide a summation result by 2 raised to the power of t to obtain a second quotient, and determine a first shard of a truncation processing result based on the second quotient.

In some embodiments, the m groups include a first group, and a type of target processing on the first group is performed by p participants including the first participant in the n participants, where p<n.

Functions of function modules in the above-mentioned apparatus embodiments of this specification can be implemented by performing the steps in the above-mentioned method embodiments. Therefore, a specific working process of the apparatuses provided in one or more embodiments of this specification are omitted here for simplicity.

The secure multi-party computation apparatus provided in one or more embodiments of this specification can effectively improve network resource and computing resource utilization.

According to one or more embodiments of another aspect, a computer-readable storage medium is further provided. The computer-readable storage medium stores a computer program. When the computer program is executed in a computer, the computer is enabled to perform the method described with reference to FIG. 2 or FIG. 3.

According to one or more embodiments of still another aspect, a computing device is further provided. The computing device includes a memory and a processor. The memory stores executable code. When executing the executable code, the processor implements the method described with reference to FIG. 2 or FIG. 3.

The embodiments in this specification are described in a progressive way. For the same or similar parts of the embodiments, references can be made between the embodiments. Each embodiment focuses on a difference from other embodiments. Particularly, the device embodiments are basically similar to the method embodiments, and therefore are described briefly. For related parts, references can be made to related descriptions in the method embodiments.

The methods or the algorithm steps described in the disclosed content of this specification can be implemented by hardware, or can be implemented by executing software instructions by a processor. The software instructions can include a corresponding software module. The software module can be stored in a RAM memory, a flash memory, a ROM memory, an EPROM memory, an EEPROM memory, a register, a hard disk, a removable hard disk, a CD-ROM, or any other form of storage medium well-known in the art. An example storage medium is coupled to the processor, so the processor can read information from the storage medium and can write information to the storage medium. Certainly, the storage medium can altematively be a component of the processor. The processor and the storage medium can be located in an ASIC. In addition, the ASIC can be located in a server. Certainly, the processor and the storage medium can alternatively exist in the server as discrete components.

A person skilled in the art should be aware that in the above-mentioned one or more examples, functions described in this specification can be implemented by hardware, software, firmware, or any combination thereof. When being implemented by software, these functions can be stored in a computer-readable medium or transmitted as one or more instructions or code on a computer-readable medium. The computer-readable medium includes a computer storage medium and a communication medium, where the communication medium includes any medium that enables a computer program to be transmitted from one place to another. The storage medium can be any available medium accessible to a general-purpose or dedicated computer.

Some specific embodiments of this specification are described above. Other embodiments fall within the scope of the appended claims. In some cases, actions or steps described in the claims can be performed in a sequence different from that in the embodiments and the desired results can still be achieved. In addition, the process depicted in the accompanying drawings does not necessarily need a particular sequence or a sequential sequence to achieve the desired results. In some implementations, multi-tasking and parallel processing are feasible or may be advantageous.

The objectives, technical solutions, and beneficial effects of this specification are further described in detail in the above-mentioned detailed description of embodiments. It should be understood that the above-mentioned descriptions are merely some specific implementations of this specification, but are not intended to limit the protection scope of this specification. Any modification, equivalent replacement, improvement, etc. made based on the technical solutions in this specification shall fall within the protection scope of this specification.

1. A secure multi-party computation method, used to perform at least one type of target processing on a batch of data, wherein each piece of data in the batch of data is distributed to n participants in a form of shards, and the method is performed by any first participant in the n participants, and comprises:
dividing local shards of each piece of data in the batch of data into m groups, and correspondingly allocating the m groups to m groups of threads; and
performing, on the m groups in parallel by using the m groups of threads, each type of target processing jointly performed with another participant, wherein the first participant serves as different secure multi-party computation (MPC) roles in at least some of the m groups of threads, and the different MPC roles perform different target computation and/or target transmission for a type of target processing.

2. The method according to claim 1, wherein performing, on the m groups in parallel by using the m groups of threads, each type of the target processing jointly performed with another participant comprises:
jointly performing, by using an i^{th} group of threads and based on a local shard of a first group that is allocated to the i^{th} group of threads, first computation and first transmission with another group of threads to which another shard of the first group is allocated in the another participant, to implement a type of target processing on the first group, wherein the first computation and the first transmission correspond to a first role of the first participant in the i^{th} group of threads.

3. The method according to claim 2, wherein the type of target processing is truncation processing, and the different MPC roles comprise a computing party and a receiving party.

4. The method according to claim 3, wherein the first group comprises first data, and the first role is the computing party;
the first computation comprises: generating a first random number within an agreed value range; dividing the first random number by 2 raised to the power of t to obtain a first quotient; and determining a first shard of a truncation processing result of the first data based on at least the first quotient, wherein t is a quantity of truncated bits; and
the first transmission comprises: sending a difference between a first shard of the first data and the first random number to a second participant serving as the receiving party, so that the second participant determines a second shard of the truncation processing result based on at least the difference, the quantity of truncated bits, and a second shard of the first data that is held by the second participant.

5. The method according to claim 3, wherein the first group comprises first data, and the first role is the receiving party;
the first transmission comprises: receiving, from a second participant serving as the computing party, a difference, calculated by the second participant, between a second shard of the first data that is held by the second participant and a first random number; and
the first computation comprises: summing the difference and a first shard of the first data, and dividing a summation result by 2 raised to the power of t to obtain a second quotient; and
determining a first shard of a truncation processing result based on the second quotient.

6. The method according to claim 1, wherein the at least one type of target processing comprises some of oblivious transfer (OT), logical quantity to digital quantity conversion, digital quantity to logical quantity conversion, multiplication of a digital quantity and a logical quantity, encrypted-state selection, or out-of-order processing.

7. The method according to claim 1, wherein dividing the local shards of each piece of data in the batch of data into m groups comprises:
equally dividing the local shards of each piece of data in the batch of data into the m groups.

8. The method according to claim 1, wherein the n participants hold a same quantity of shards for a same piece of data in the batch of data.

9. The method according to claim 1, wherein the batch of data are unevenly distributed to the n participants, and an MPC role of each of the n participants is determined based on data currently held by the participant.

10. The method according to claim 1, wherein the m groups comprise a first group, and a type of target processing on the first group is performed by p participants comprising the first participant in the n participants, wherein p<n.

11. The method according to claim 1, wherein the m groups of threads comprise different quantities of threads.

12. The method according to claim 1, wherein the n participants run different quantities of threads.

13-23. (canceled)

24. A non-transitory computer-readable storage medium, wherein the non-transitory computer-readable storage medium stores a computer program, which when executed by a processor causes the processor to:
divide local shards of each piece of data in the batch of data into m groups, and correspondingly allocate the m groups to m groups of threads; and
perform, on the m groups in parallel by using the m groups of threads, each type of target processing jointly performed with another participant, wherein the first participant serves as different secure multi-party computation (MPC) roles in at least some of the m groups of threads, and the different MPC roles perform different target computation and/or target transmission for a type of target processing.

25. A computing device, comprising a memory and a processor, wherein the memory stores executable code, and when executing the executable code, the computing device is caused to:
divide local shards of each piece of data in the batch of data into m groups, and correspondingly allocate the m groups to m groups of threads; and
perform, on the m groups in parallel by using the m groups of threads, each type of target processing jointly performed with another participant, wherein the first participant serves as different secure multi-party computation (MPC) roles in at least some of the m groups of threads, and the different MPC roles perform different target computation and/or target transmission for a type of target processing.

26. The non-transitory computer-readable storage medium according to claim 24, wherein the processor being caused to perform, on the m groups in parallel by using the m groups of threads, each type of the target processing jointly performed with another participant comprises being caused to:
jointly perform, by using an i^{th} group of threads and based on a local shard of a first group that is allocated to the i^{th} group of threads, first computation and first transmission with another group of threads to which another shard of the first group is allocated in the another participant, to implement a type of target processing on the first group, wherein the first computation and the first transmission correspond to a first role of the first participant in the i^{th} group of threads.

27. The non-transitory computer-readable storage medium according to claim 26, wherein the type of target processing is truncation processing, and the different MPC roles comprise a computing party and a receiving party.

28. The non-transitory computer-readable storage medium according to claim 27, wherein the first group comprises first data, and the first role is the computing party;
the first computation comprises: generating a first random number within an agreed value range; dividing the first random number by 2 raised to the power of t to obtain a first quotient;
and determining a first shard of a truncation processing result of the first data based on at least the first quotient, wherein t is a quantity of truncated bits; and
the first transmission comprises: sending a difference between a first shard of the first data and the first random number to a second participant serving as the receiving party, so that the second participant determines a second shard of the truncation processing result based on at least the difference, the quantity of truncated bits, and a second shard of the first data that is held by the second participant.

29. The computing device according to claim 25, wherein the computing device being caused to perform, on the m groups in parallel by using the m groups of threads, each type of the target processing jointly performed with another participant comprises being caused to:
jointly perform, by using an i^{th} group of threads and based on a local shard of a first group that is allocated to the i^{th} group of threads, first computation and first transmission with another group of threads to which another shard of the first group is allocated in the another participant, to implement a type of target processing on the first group, wherein the first computation and the first transmission correspond to a first role of the first participant in the i^{th} group of threads.

30. The computing device according to claim 29, wherein the type of target processing is truncation processing, and the different MPC roles comprise a computing party and a receiving party.

31. The computing device according to claim 30, wherein the first group comprises first data, and the first role is the computing party;
the first computation comprises: generating a first random number within an agreed value range; dividing the first random number by 2 raised to the power of t to obtain a first quotient; and determining a first shard of a truncation processing result of the first data based on at least the first quotient, wherein t is a quantity of truncated bits; and
the first transmission comprises: sending a difference between a first shard of the first data and the first random number to a second participant serving as the receiving party, so that the second participant determines a second shard of the truncation processing result based on at least the difference, the quantity of truncated bits, and a second shard of the first data that is held by the second participant.
